(19) United States
(12) Patent Application Publication
(10) Pub. No.: US 2021/0249213 A1
(43) Pub. Date: Aug. 12, 2021

(54) ELECTRON COLLECTOR WITH THERMAL INSERT

(71) Applicant: Richardson Electronics, Ltd., LaFox, IL (US)

(72) Inventors: Min He, Downers Grove, IL (US); Norman Wandke, Naperville, IL (US); Brice Youngren, Plainfield, IL (US); Thomas Muchowicz, Elk Grove Village, IL (US)

(21) Appl. No.: 16/786,197

(22) Filed: Feb. 10, 2020

(51) Int. Cl. H01J 35/06; H01J 35/14; H01J 35/12

(52) U.S. Cl. CPC H01J 35/064; H01J 2235/167; H01J 35/12; H01J 35/14

(57) ABSTRACT

An electron collector for an x-ray tube having an electron collector base and an electron collector insert. The electron collector insert may be composed of a thermally enhanced material and is used to mitigate thermal stress from the electron collector. The electron collector insert may further prevent cracking and thermal fatigue of the electron collector.

### BACKGROUND

### 1. Field

Embodiments of the invention relate to x-ray tubes. More specifically, embodiments of the invention relate to x-ray tubes with thermally enhanced electron collectors.

### 2. Related Art

X-ray tubes are used to convert electrical input into x-rays. In an x-ray tube a cathode emits electrons into a vacuum of the x-ray tube. A large voltage between the cathode and anode accelerates the electrons towards the anode, where they strike the x-ray target surface. As the electrons strike the target, a portion of them are backscattered, and a portion have a number of inelastic collisions with both the electrons and the nuclei of the target atoms. The process of the electrons decelerating and changing directions in the target material produces x-rays. The x-rays are emitted in a hemispherical pattern from the surface of the target. Some of the x-rays then travel through the vacuum inside the x-ray tube and pass through an x-ray transparent window, typically made from beryllium. From here they travel through the tube housing window and a collimator and can then be used for diagnostic purposes in a CT scanner. About 40% of the electrons are backscattered from the target and these can bombard the cathode and cathode insulator. As they bombard the cathode insulator, the electrons will charge up the surface, leading to changes in the insulators electric field and arcing and failure of the insulator.

The backscattered and secondary electrons may limit the performance of the x-ray tube. Typically, an electron collector is used to absorb the backscattered and secondary electrons causing the electron collector to heat up. In some cases, the heat may be extreme causing grain growth and cracking of the electron collector associated with thermal fatigue. The cracking of the electron collector typically occurs along the grain boundaries of the electron collector material.

Some x-ray tubes may have an electron collector cooling system to cool the electron collector. However, the cooling system may increase the temperature gradient across the electron collector, which may increase thermal stress and the likelihood of cracking in the electron collector. Cracks in an electron collector may cause particles and gases to be released from the x-ray tube, as well as create leakage from a cooling channel of the electron collector. In some cases, the cracks may reduce the vacuum capabilities of the x-ray tube causing the tube to fail due to a poor vacuum. What is needed is a low-cost electron collector for an x-ray tube that does not crack under the high temperature conditions associated with operation of the x-ray tube.

### SUMMARY

Embodiments of the invention solve the above-mentioned problems by providing an electron collector insert to prevent cracking of the electron collector. The electron collector insert may be secured to an electron collector base of an x-ray tube and may be comprised of a thermally enhanced material to withstand the thermal stress associated with operation of the x-ray tube.

A first embodiment of the invention is directed to an electron collector for capturing electrons of an x-ray tube, the electron collector comprising a base having an inner surface, and at least one insert disposed within the base configured to mitigate thermal stress of the electron collector, wherein an outer surface of the at least one insert is attached to the inner surface of the base, wherein the electron collector is configured to be located at an area of high temperature on the x-ray tube.

A second embodiment of the invention is directed to a system for capturing electrons, the system comprising an x-ray tube comprising a frame, a cathode, an anode, and an electron collector attached to the frame at an area of high temperature on the x-ray tube, the electron collector comprising a base, and at least one insert disposed within the base for mitigating thermal stress of the electron collector.

A third embodiment of the invention is directed to a method for capturing electrons of an x-ray tube, said x-ray tube comprising an anode and a cathode within a vacuum, the method comprising the steps of emitting electrons from the cathode towards the anode to form an electron beam, absorbing backscattered and secondary electrons with an electron collector disposed between the cathode and the anode, the electron collector comprising a base attached to the x-ray tube, and at least one insert disposed within the base, and mitigating thermal stress from the electron collector using the at least one insert.

Yet another embodiment is directed to a system for cooling an electron collector of an x-ray tube using an electron collector insert and an electron collector cooling system.

Additional embodiments of the invention are directed to a method for mitigating thermal stress of an electron collector of an x-ray tube using an electron collector insert.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1 is an exemplary x-ray tube;

FIG. 2A is a first embodiment of an electron collector with a base and an insert;

FIG. 2B is an exploded view of the first embodiment of an electron collector;

FIG. 2C is an exploded view of the first embodiment of an electron collector including an additional coating;

FIG. 2D is a cross-sectional view of the first embodiment of an electron collector;

FIG. 3 is an exemplary heat map of a cross-section of the first embodiment of an electron collector;

FIG. 4A is a cross-sectional view of a second embodiment of an electron collector with a tapered insert;

FIG. 4B is a third embodiment showing a curved plate insert for an electron collector of an x-ray tube;

FIG. 4C is a fourth embodiment of an electron collector showing a plurality of fin inserts;

FIG. 4D is a fifth embodiment of an electron collector showing a threaded insert and base.

FIG. 5 is an exemplary depiction of a microstructure of a metal matrix composite material for an insert of an electron collector;

FIG. 6 is a cross-sectional view of a sixth embodiment of an electron collector having a coating;

FIG. 7 shows an exemplary method for capturing electrons of an x-ray tube for some embodiments;

FIG. 8 is a depiction of an exemplary brazing process for attaching an insert to an electron collector; and

FIG. 9 is a depiction of an exemplary electron collector cooling system.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

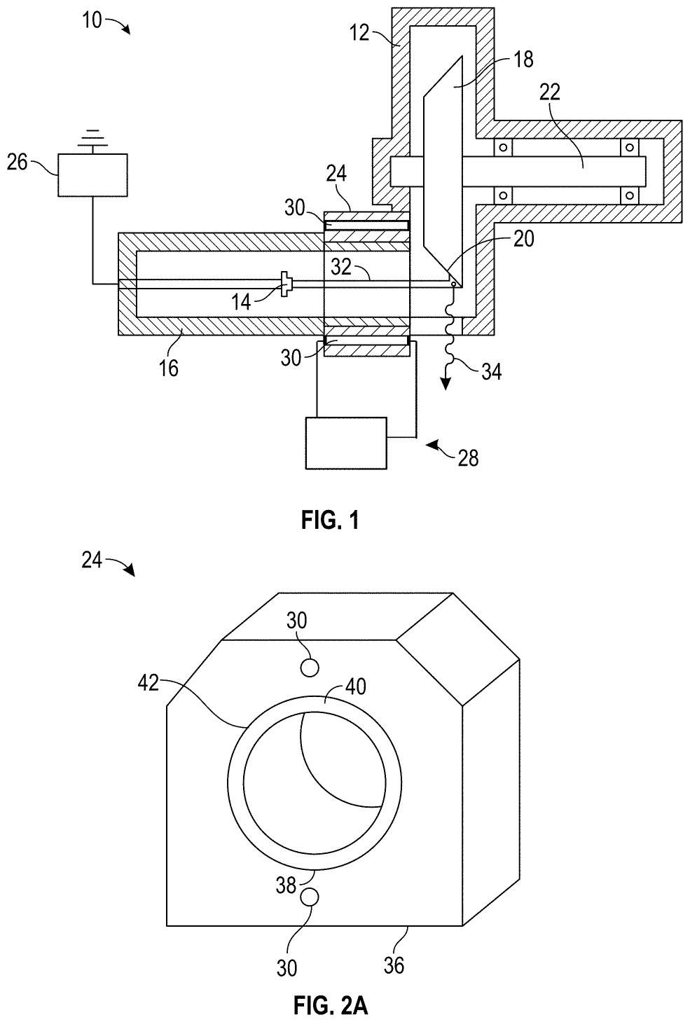

FIG. 1 depicts an x-ray tube 10 used by some embodiments. The x-ray tube 10 may comprise a frame 12, a cathode 14 with an insulator 16, an anode 18 with a target surface 20 and a shaft 22, as shown, and an electron collector 24. The x-ray tube 10 may be powered by a power source 26, which may be electrically connected to the cathode 14 and a ground potential. In some embodiments, the frame 12 may be a glass envelope, while in some other embodiments, the frame 12 may be a metal frame. The frame 12 may be evacuated to produce a vacuum within the x-ray tube 10. In some embodiments, the anode 18 may be a rotating anode 18 that rotates within the frame 12 of the x-ray tube 10, as shown. Here, the anode 18 may be coupled to the shaft 22 so that rotation of the shaft 22 provides rotation to the anode 18. In some embodiments, the x-ray tube 10 may comprise a cooling system 28. The cooling system 28 may be operable to cool at least one component of the x-ray tube 10, such as the electron collector 24. In some such embodiments, the cooling system 28 may use a coolant circulated through cooling channels 30 to cool the at least one component. The coolant may be any fluid, such as, for example, water or oil. The cooling channels 30 may be internal or external channels filled with the coolant. Heat may be transferred from the electron collector 24 into the coolant to cool the electron collector 24.

During operation of the x-ray tube 10 of FIG. 1, an electrical voltage may be supplied to the cathode 14 from the power source 26. An electrical current may flow from the cathode 14 to the anode 18 as an electron beam 32. When the electron beam 32 strikes the target surface 20 of the anode 18, x-rays 34 are produced as the electrons are decelerated within the anode 18. The x-rays 34 may flow in a direction perpendicular to the electron beam 32. Only a portion of energy consumed by the x-ray tube 10 is used to produce and accelerate x-rays 34 and a larger portion of the energy is released in the form of heat. Backscattered electrons and secondary electrons may be produced from the electron beam 32 striking the target surface 20. The electron collector 24 may be used to absorb the backscatter electrons and secondary electrons. Electrons may be absorbed into the electron collector 24 as heat which increases the temperature of the electron collector 24, especially on the inner surface of the electron collector 24 that faces the electron beam 32.

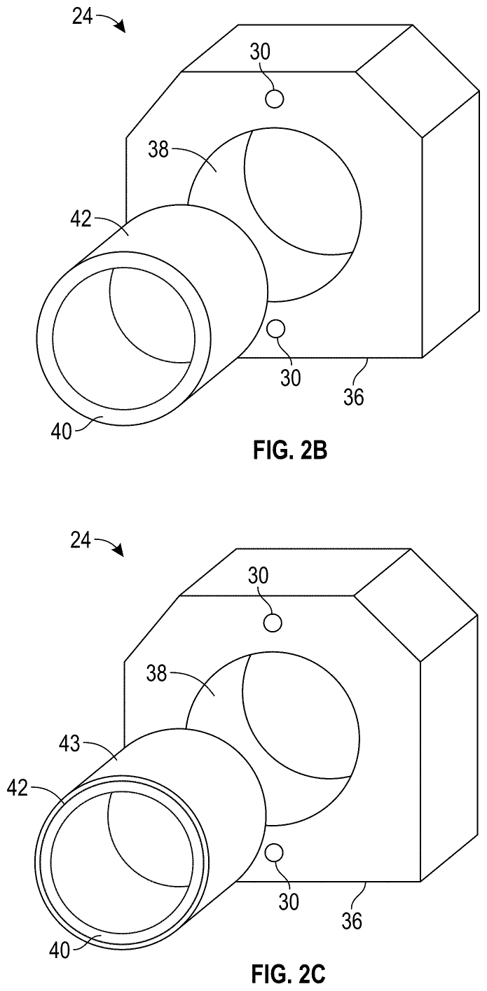

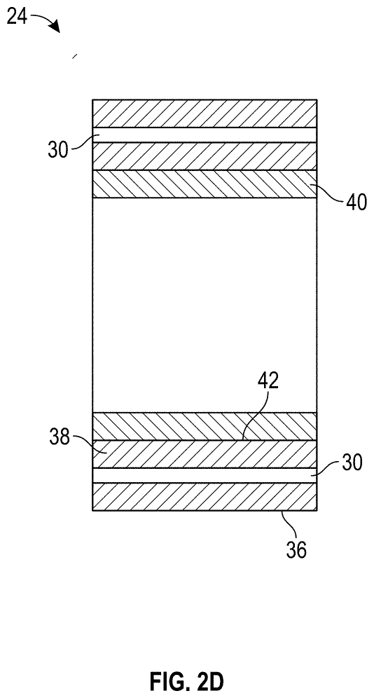

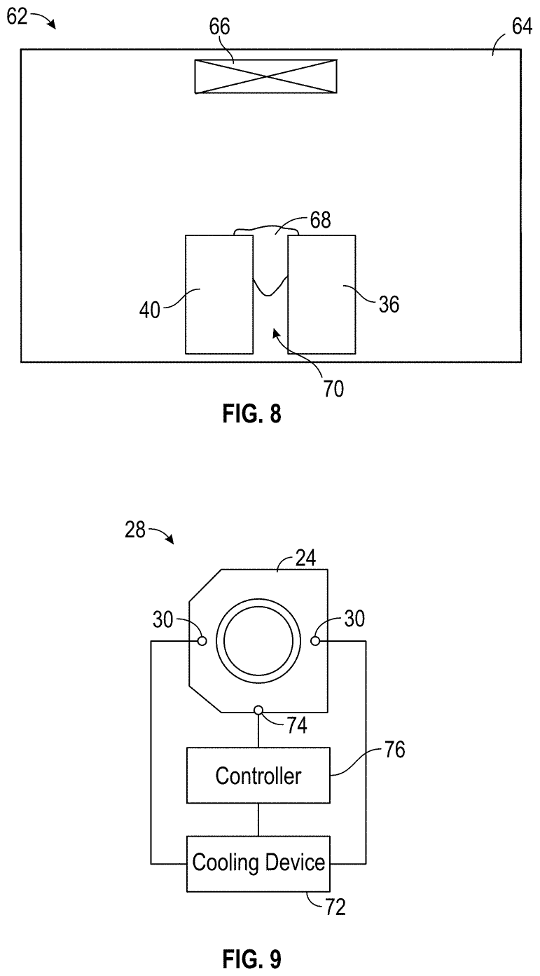

FIG. 2A depicts an electron collector 24 for some embodiments. The electron collector 24 comprises a base 36 with a base inner surface 38 and an insert 40 with an insert outer surface 42. In some embodiments, the insert 40 may be disposed within the base 36. It may be desirable to attach the insert 40 to the base 36 by securing the insert outer surface 42 to the base inner surface 38, as shown. The connection of the base 36 and insert 40 may provide contact between the base inner surface 38 and the insert outer surface 42. In some embodiments, the insert 40 may be brazed to the base 36 using a brazing process 62, as will be discussed below in reference to FIG. 8. In some embodiments, the insert 40 may be permanently secured to the base 36, while in some other embodiments, the insert 40 may be removably attached to the base 36. In embodiments where the insert 40 is removably attached to the base 36, the insert 40 may be replaceable and a new insert 40 may be attached to the base 36 after removal of the used insert 40.

In some embodiments, the electron collector 24 may further comprise at least one cooling channel 30 for the coolant of the cooling system 28 to flow through. The cooling channel 30 may be a hole through the base 36, as shown, that allows the coolant to flow through the base 36 in order to cool the base 36. Heat may be transferred from the electron collector 24 into the coolant in the cooling channel 30 to reduce the temperature of the electron collector 24. In some embodiments, the cooling channel 30 may be disposed within or adjacent to the insert 40 to draw heat directly from the insert 40. In some other embodiments, the cooling channel 30 may be located on the outside surface of the base 36 to draw heat from an outside surface of the base 36 or within the base 36, as shown.

FIG. 2B shows an exploded view of the electron collector 24 for some embodiments. In FIG. 2B the insert 40 is shown removed from the base 36, as to depict the base inner surface 38 and the insert outer surface 42. When assembled, the base inner surface 38 may be bonded to the insert outer surface 42.

FIG. 2C shows an exploded view of the electron collector 24 for some embodiments, further including a coating 43 that may be disposed on a surface of the insert 40. The coating 43 may be applied to the insert outer surface 42 of the insert 40, as shown, to provide a joining surface. The joining surface may be brazed or diffusion bonded to the base 36. Thus, the coating 43 may provide a brazing or diffusion bonding surface. Accordingly, the material of the coating 43 may be selected based on compatibility with the selected joining process used to join the insert 40 to the base 36. In some embodiments, the base inner surface 38 may additionally or alternatively have a coating 43 for ease in joining the base 36 to the insert 40.

FIG. 2D shows a cross-sectional view of the cross-section of the electron collector 24. Here, the electron collector 24 can be seen with the insert 40 attached to the base 36. The base 36 may have cooling channels 30 running through the base 36, as shown.

Each of the base 36 and the insert 40 may be operable to absorb secondary electrons and backscattered electrons from the x-ray tube 10. In some cases, the electron collector 24 may absorb up to 30% of power input into the x-ray tube 10 in the form of secondary and backscattered electrons causing the electron collector 24 to heat up. The electron collector 24 may be operable to absorb electrons in order to reduce heating of other components of the x-ray tube 10. In some embodiments, the electron collector 24 and the cooling system 28 provide a means to remove excess heat from the x-ray tube 10.

In some embodiments, the base 36 may be composed of an oxygen free high conductivity (OFHC) copper material. OFHC copper material may be selected based on material properties, such as, for example, thermal conductivity, outgassing rate, and vacuum compatibility. As described above typical electron collector materials like OFHC copper may be prone to cracking. The cracking may be associated with undesirable properties of the OFHC copper, such as, for example, relatively low yield strength, and susceptibility to grain growth. It should be understood that in some embodiments, any suitable material may be used for the base 36 of the electron collector 24.

In some embodiments, the insert 40 may be composed of a metal matrix composite (MMC) material, such as, for example, Glidcop®, cobalt reinforced with tungsten carbide, steel reinforced with boron nitride, and copper-silver alloy reinforced with diamond. Glidcop® is composed of a copper matrix reinforced with dispersed aluminum oxide particles. The aluminum oxide particles have a pinning effect that locks grain boundaries within the material and slows grain growth to prevent cracking of the electron collector 24. Glidcop® may be a desirable material for the insert 40 because of its thermal and structural properties. Glidcop® may be suitable to withstand the high temperatures associated with operation of the x-ray tube 10 while preventing cracking of the electron collector 24. It should be understood that in some embodiments, any suitable material may be used for the insert 40.

Materials with desirable thermal properties, such as Glidcop®, may be relatively expensive when compared with typical electron collector materials, such as OFHC copper. Accordingly, in some embodiments, the x-ray tube 10 comprises the electron collector 24 with the insert 40 covering only a portion of the electron collector 24. The base 36 of the electron collector 24 may be composed of a less expensive material. For example, a Glidcop® insert 40 may be disposed on the inner surface of a copper base 36. Typically, the inner surface of the collector experiences the highest thermal stress, so the insert 40 may be placed on the inner surface of the base 36 in some embodiments.

In some embodiments, the thickness of the insert 40 may be about 0.25 inch to about 0.75 inch. It should be understood that a variety of thicknesses may be desirable based on the size of the x-ray tube 10 and the operating conditions of the x-ray tube 10 (i.e., operating temperature). For example, it may be desirable to include insert 40 with a thickness greater than 0.75 inch in an x-ray tube 10 with a relatively high operating temperature. The thickness of the insert 40 may be limited based on the cost of the insert 40 and the ability of the insert 40 to fit within the base 36.

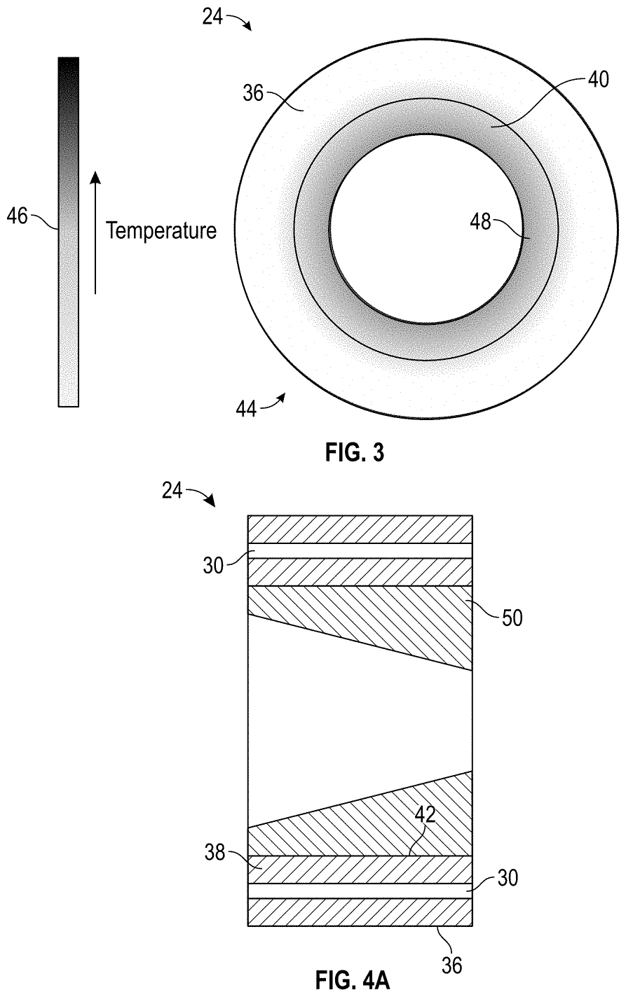

FIG. 3 shows an exemplary heat map 44 for a cross-section of an electron collector 24. The heat map 44 has a gradient fill representing the temperature at various locations across the electron collector 24 according to a temperature key 46, as shown. The inner surface of the electron collector 24 may be at a higher temperature than the outer surface, as shown. In some embodiments, a hotspot 48 may be located on the electron collector 24. The hotspot 48 may be an area of increased temperature in the electron collector 24. Accordingly, it may be desirable to dispose the insert 40 along the inner surface of the collector and the base 36 along the outer surface of the electron collector 24, as shown. The insert 40 may be better suited to withstand high temperatures based on the material properties of the insert 40, when compared with the base 36. Additionally, in some embodiments, the temperature may vary across the length of the electron collector 24 (not shown). In some embodiments, it may be desirable to vary the thickness of the cross-section of the insert 40 so that the insert 40 is thicker in locations that experience a higher temperature. The electron collector 24 shown in FIG. 3 is of a cylindrical shape, however, in some embodiments, various other shapes of the electron collector 24 may be implemented. For example, the electron collector 24 may be a plate, a cube, or various other shapes. In some embodiments, the electron collector 24 is hollow to allow the electron beam 32 to pass through the electron collector 24 so that the electron beam 32 can reach the anode 18. In some embodiments, the electron collector 24 may comprise a plurality of electron collectors disposed in various locations of the x-ray tube 10. For example, embodiments are contemplated that include electron collectors disposed around the anode 18, such as on the frame 12 behind the anode 18 on the opposite side of the electron beam 32. Here the electron collectors may absorb electrons that may be scattered around the anode 18 to shield the anode 18 and the frame 12.

In some embodiments, the insert 40 is disposed at a hotspot 48 of the electron collector 24. The hotspot 48 may be a location of increased temperature and thermal stress associated with operation of the x-ray tube 10. By supplementing the base 36 of the electron collector 24 with the insert 40 at a hotspot 48 of the electron collector 24, the overall thermal stress experienced by the base 36 of the electron collector 24 may be mitigated. As such, failure modes, such as thermal fatigue of the electron collector 24 may be avoided. In some embodiments, the configuration of the electron collector 24 may be selected based on the temperature of the electron collector 24 during operation of the x-ray tube 10. Accordingly, in some embodiments, the insert 40 may be disposed at a higher operating temperature location of the electron collector 24 and the base 36 may be disposed at a lower operating temperature location of the electron collector 24. The insert 40 may have better high temperature stability than the base 36 to withstand the higher operating temperature. In some embodiments, the insert 40 may be disposed on the base inner surface 38 so that it covers at least a portion of the base inner surface 38.

As discussed above, in some embodiments, the insert 40 may be placed on the inner surface 38 of the base 36 so that the insert 40 experiences the highest temperature within the electron collector 24. The base 36 may be disposed on the cooler outer portion of the electron collector 24. In some embodiments, the insert 40 is used as a thermal shield to block the base 36 from high temperatures. The insert 40 may transfer heat to the base 36 but the temperature of the base 36 may be held below a threshold temperature. The threshold temperature may be a desirable operating temperature for the base 36 that does not cause the material of the base 36 to crack. The threshold temperature may be determined based on the material of the base 36. Accordingly, the threshold temperature may be a maximum temperature of a desirable operating temperature range of the base 36. In some embodiments, each component of the x-ray tube 10 may be associated with a respective desirable operating temperature range. For example, the base 36 may have a desired operating temperature range from 0° C. to 700° C., the insert 40 may have a desired operating temperature range from 0° C. to 900° C., and the anode 18 may have a desired operating temperature range from 0° C. to 1300° C. It should be understood that different embodiments may have different desired operating temperature ranges. In some embodiments, the desired operating temperature range for each component may be based on the material properties, size, and shape of the component. In some embodiments, the insert 40 may be disposed at a location on the electron collector 24 that experiences a temperature higher than the threshold temperature of the base 36.

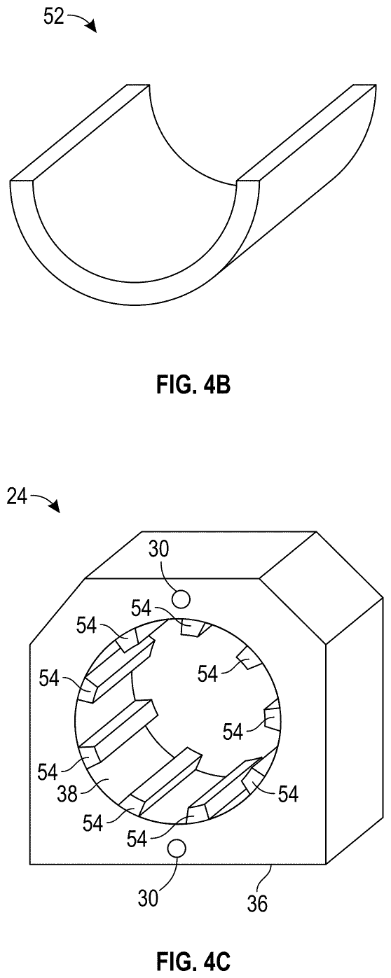

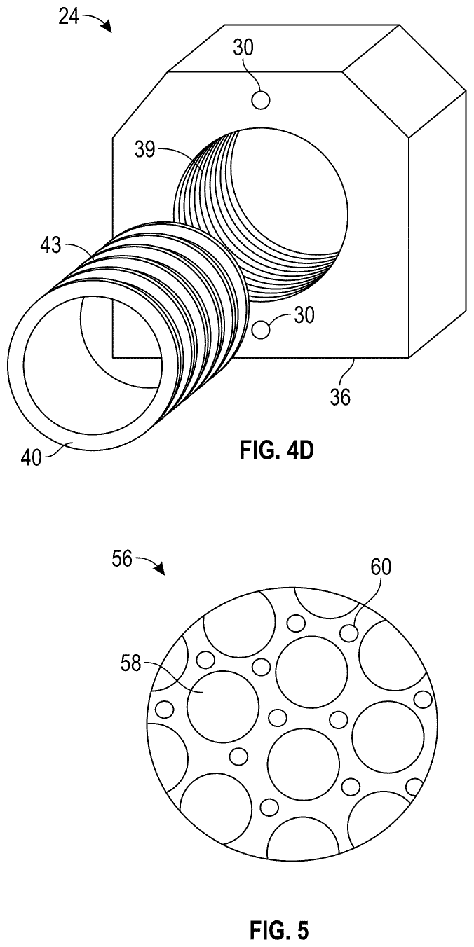

FIG. 4A shows a cross-sectional view of electron collector 24 with a tapered insert 50 that may be used as the insert 40 of the electron collector 24 in some embodiments. In such embodiments, the insert 40 may be cone-shaped and tapered on the inner surface, as shown. The tapered insert 50 may be desirable to focus the secondary and backscattered electrons for collection. The tapered insert 50 may also be desirable because the cross-section of the tapered insert 50 becomes thicker on one end. The thicker end may be disposed adjacent to the anode 18 at a location, which in some embodiments may be a higher temperature location. In some embodiments, the shape of the insert 40 may be any of a variety of suitable shapes, such as, for example, cylindrical, cone-shaped, spherical, cube-shaped, bowl-shaped, etc. In some embodiments, the shape of the insert 40 and the shape of the base 36 may be selected based on the shape of the x-ray tube 10, so that the electron collector 24 fits into the x-ray tube 10 at a desired location.

FIG. 4B shows a curved plate insert 52 that may be used as the insert 40 of the electron collector 24 in some embodiments. In some embodiments, the electron collector 24 may comprise a plurality of curved plate inserts 52. The curved plate inserts 52 may be placed at various locations along the inner surface of the base 36 of the electron collector 24, and may extend along the entire length of the electron collector 24 or be located at discrete portions thereof.

FIG. 4C shows an electron collector 24 having a plurality of fin inserts 54. The fin inserts 54 may be used as the insert 40 of the electron collector 24 in some embodiments. It may be desirable to use the fin inserts 54 to increase the overall electron collecting capabilities of the electron collector 24. The plurality of fin inserts may include any number thereof, such as 2-10 fins. The shape of the fin inserts 54 may also increase the heat transfer rate to remove more heat from the x-ray tube 10. In some embodiments, a plurality of fin inserts 54 may be used, as shown, or a single fin insert 54 may be used (not shown). The fin inserts 54 may be positioned along the inner surface of the electron collector 24. FIG. 4C shows the electron collector 24 comprising the base 36 and the plurality of fin inserts 54 attached to the base inner surface 38. The fin inserts 54 may be spaced radially and equidistantly along the circumference of the base inner surface 38, as shown. Alternatively, the fin inserts 54 may be spaced unequally or be concentrated around at least one hotspot 48. Here, the electron beam 32 may run through the center of the electron collector 24. The fin inserts 54 may be configured to absorb heat, secondary electrons, and backscattered electrons. The fin inserts 54 may be disposed at the highest temperature location of the electron collector 24. In some embodiments, electrons and heat may be absorbed by the fin inserts 54 and travel through the fin inserts 54 to the base 36 of the electron collector 24. The base 36 of the electron collector 24 may be cooled by the cooling system 28, as shown in FIG. 1.

In some embodiments, the size and shape of the insert 40 and the base 36 may be selected according to the size and desired operating conditions of the x-ray tube 10. For example, for a large x-ray tube 10 that generates a large amount of energy it may be desirable that the insert 40 and the base 36 have thicker cross sections than a smaller x-ray tube 10 with low energy generation. Additionally, an x-ray tube 10 with a different geometry may have hotspots 48 in different locations. Accordingly, in some embodiments, it may be desirable to adjust the shape of the insert 40 or the location of the insert 40 based on the geometry of the x-ray tube 10.

FIG. 4D shows an embodiment of electron collector 24 comprising base 36 with a threaded base inner surface 39 and insert 40 with a threaded insert outer surface 43. The threaded base inner surface 39 and the threaded insert outer surface 43 may allow the insert 40 to be threaded into the base 36. Thus, the insert 40 can be removably attached to the base 36 by rotating the insert 40 independently from the base 36. In some embodiments, the threads of the threaded base inner surface 39 and the threaded insert outer surface 43 may be matching threads. The sizing of the threads may be selected based on the size of the base 36 and the insert 40.

FIG. 5 shows an exemplary depiction of a microstructure of an MMC material 56 for some embodiments. The MMC material 56 may be composed of a base material 58, which may be a metal matrix, and a reinforcement material 60 dispersed into the base material 58, which may be another metal or a different material. In some embodiments, the base material 58 may be copper and the dispersed reinforcement material 60 may be aluminum oxide particles. As discussed above, the MMC material 56 may be used for the insert 40. The dispersed particles may be smaller than the particles of the base material 58 and may restrict movement and grain growth within the microstructure of the MMC material 56. The reinforcement material 60 may restrict the cracking along the grain boundaries associated with typical electron collector materials, as mentioned above, by reinforcing the grain boundaries. In some embodiments, the reinforcement material 60 may have its own microstructure, such as, for example, whiskers, short fibers, or particles. In some embodiments, the reinforcement material 60 may be dispersed into the base material 58 using various dispersion techniques, such as, for example, solid state methods, liquid state methods, semi-solid state methods, vapor deposition, or in-situ fabrication.

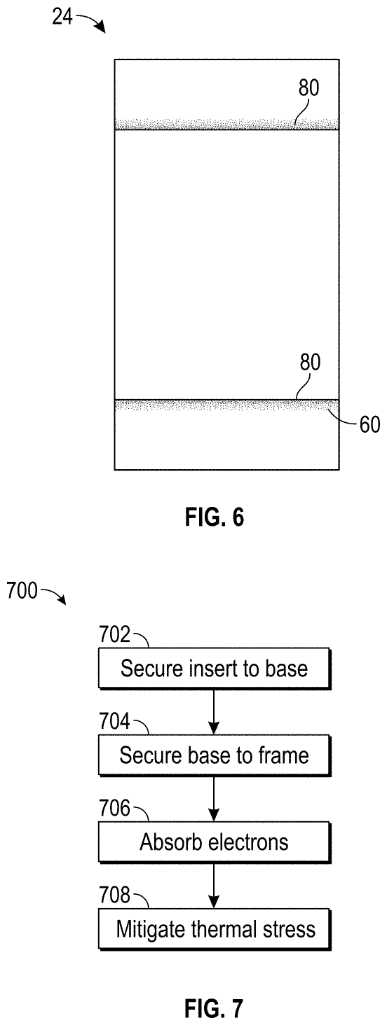

In some embodiments, it may be desirable to coat a material on an inner surface of the electron collector 24. In such embodiments, the electron collector 24 may comprise a single part that has at least one surface that is provided with coating 80 to thermally enhance the surface, as shown in FIG. 6. In some such embodiments, the location of the coated surface may be selected based on a hotspot 48 within the electron collector 24. Thus, the electron collector 24 may be thermally enhanced by coating 80 at a hotspot 48 of the electron collector 24 that experiences a relatively high temperature during operation of the x-ray tube 10. For example, the coating may be applied on the inner surface of the electron collector 24 that faces the electron beam 32. In some embodiments, the coating 80 may comprise reinforcement material 60 which may be dispersed particles.

In some embodiments, it may be desirable to include the coating 80 as a thin film on the surface of the electron collector 24. In some other embodiments, it may be desirable to embed the coating into the electron collector. As such, the dispersed particles may be embedded into the inner surface or outer surface of the electron collector 24 at a dispersion depth. The dispersion depth may extend into the thickness of the electron collector 24. In some embodiments, the dispersion depth may be selected based on the thermal properties of the material and the location of a hotspot 48 on the electron collector 24. For example, an electron collector 24 may have a dispersion depth of about 0.25 inch at a hotspot 48 on the surface of the electron collector 24 and a dispersion depth of about 0.1 inch at another point on the surface of the electron collector 24.

To apply the coating 80 to the electron collector 24 various techniques may be used such as a vapor deposition process. In some embodiments, a sputtering process may be used to add a thin film of coating 80 to the surface of the electron collector 24. It should be understood that various other dispersion techniques may be used to apply the coating 80 or to embed particles into the electron collector 24. The specific technique that is used to apply the coating may be selected based on the specific materials of the electron collector and the coating.

FIG. 7 shows a method 700 for capturing electrons for some embodiments. The method may comprise step 702 where the insert 40 is secured to the base 36. The insert 40 may be secured to the base 36 using a variety of processes, such as, for example, welding, brazing, or diffusion bonding. Other joining processes for securing the insert 40 to the base 36 will be discussed below. At step 704 the base 36 of the electron collector 24 is secured to a frame 12 of the x-ray tube 10 to support the electron collector 24. The base 36 and frame 12 may be secured using any of the joining processes discussed herein for securing the insert 40 to the base 36. In some embodiments the joining process for securing the insert 40 to the base 36 may be the same as the joining process for securing the base 36 to the frame 12, while other embodiments may use different joining processes. In some embodiments, the electron collector 24 may also be secured to the insulator 16 of the cathode 14 using any joining process described herein. In some embodiments, a specific joining process may be used to join each of the components. Selection of the specific joining process may be based on the material properties of the components that are being joined.

At step 706, the electron collector 24 absorbs electrons from the x-ray tube 10. The absorbed electrons may be a combination of secondary electrons and backscattered electrons. In some embodiments, the absorbed electrons are excess electrons that do not aid in the production of diagnostic x-rays 34. The excess electrons may reduce the performance of the x-ray tube 10. The step 706 of absorbing the electrons may produce heat within the electron collector 24. At step 708, thermal stress of the electron collector 24 is mitigated using the insert 40. The insert 40 may mitigate thermal stress from the electron collector 24 by absorbing heat that would otherwise be absorbed by the base 36 of the electron collector 24. As discussed above, the insert 40 may have better high-temperature stability than the base 36 and can therefore better withstand the high-temperature operating conditions of the x-ray tube 10. The base 36 may be disposed in a location of the x-ray tube 10 with a lower operating temperature. Thus the thermal stress on the base 36 associated with being placed in the high-operating temperature location of the insert 40 is mitigated. Further, in some embodiments, the insert 40 may be a shield to cover the base 36 from the hotspot 48 within the electron collector 24.

FIG. 8 shows a brazing process 62 for some embodiments of the invention. The brazing process 62 may be used to secure the insert 40 to the base 36. In some embodiments, the brazing process 62 is a furnace brazing process 62 having a vacuum environment 64, as shown, wherein parts are placed into the vacuum environment 64 of a furnace to be brazed. The vacuum environment 64 may be a controlled environment and in some embodiments, may be a hydrogen environment or other suitable gas environment. Further, in some embodiments, the vacuum environment 64 may be a partial pressure environment. During the brazing process 62 a heat source 66 of the furnace may be used to provide heat. The heat source 66 may be used to heat a filler metal 68 to a temperature slightly above a melting temperature of the filler metal 68 so that the filler metal 68 is melted. The melted filler metal 68 flows into a gap 70 between the insert 40 and the base 36 by capillary action to join the insert 40 to the base 36. After the flowing of the filler metal 68 into the gap 70, the filler metal 68 may be cooled below the melting temperature to solidify the filler metal 68. Thus, the insert 40 is secured to the base 36. In some embodiments, other components may be brazed using the furnace brazing process 62, such as, for example, the base 36 may be brazed to the frame 12 of the x-ray tube 10.

It should be understood that in some embodiments, other joining processes may be used to secure the insert 40 to the base 36, such as, for example, diffusion bonding, welding, fastening, press fitting, adhesion, and soldering. In some embodiments, it may be desirable to create a joint between the insert 40 and base 36 with substantial contact to allow heat transfer and the flow of electricity between the insert 40 and the base 36. It may also be desirable for the joint to have sufficient bonding strength and sufficient structural support to secure the insert 40 to the base 36. Contact between a surface of the insert 40 and a surface of the base 36 may allow heat to transfer from the insert 40 to the base 36 across the joint. In some embodiments, the heat transfer across the joint may allow a portion of the heat to flow through the base 36 and be removed using the cooling system 28.

In some embodiments, the specific joining process that is used to join the insert 40 to the base 36 may be determined based on the material used for the insert 40 and the material used for the base 36. Different joining processes may be better suited for joining different materials, especially considering a process temperature of the joining process. For example, a brazing process with a process temperature above 1000° C. would not be suitable to braze a material with a melting temperature below 1000° C., as the base material would be melted. Accordingly, the joining process may be selected based on a thermal property of the material of the insert 40 and a thermal property of the material of the base 36.

In some embodiments, the insert 40 may be removably attached to the base 36, as mentioned above. In some such embodiments, the insert 40 may be attached to the base 36 using at least one fastener (not shown). The fastener may be any of a screw, a bolt, or any other type of mechanical fastener. In some embodiments, the base inner surface 38 and the insert outer surface 42 may be threaded, as discussed above in reference to FIG. 4D.

FIG. 9 shows a cooling system 28 for an embodiment. The cooling system 28 may comprise cooling device 72, cooling channels 30, and a temperature sensor 74. In some embodiments, the cooling system 28 may be used to cool the electron collector 24 during operation of the x-ray tube 10. In some such embodiments, at least one temperature sensor 74 may be placed on the electron collector 24. For example, the temperature sensor 74 may be disposed on an outer surface of the base 36 of the electron collector 24, as shown. In some embodiments, the temperature sensor 74 may send a signal indicative of a temperature of the electron collector 24 to a controller 76. The controller 76 may receive the signal and determine an output signal to be sent to the cooling device 72. The output signal may determine a state of the cooling device 72. For example, the output signal may trigger the cooling device 72 to be activated or deactivated, lower or raise the temperature of the coolant, or increase or decrease a flow rate of the coolant. In some embodiments, the controller 76 may be operable to control the flow rate of the coolant through the cooling system 28 according to the temperature of the electron collector 24 as sensed by temperature sensor 74. In some embodiments, the temperature sensor 74 may be disposed on the insert 40 of the electron collector 24 to relay a signal that is indicative of the temperature of the insert 40 of the electron collector 24. Further, in some embodiments, a plurality of temperature sensors 74 may be used disposed at various locations within or on the x-ray tube 10, such as, for example, on the base 36, on the insert 40, on the anode 18, and/or on the frame 12.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. An electron collector for capturing backscattered and secondary electrons of an x-ray tube, the electron collector comprising:
a base having an inner surface; and
at least one insert disposed within the base configured to mitigate thermal stress of the electron collector,
wherein an outer surface of the at least one insert is attached to the inner surface of the base,
wherein the electron collector is configured to be located at an area of high temperature on the x-ray tube.

2. The electron collector of claim 1, wherein the at least one insert is composed of a metal matrix composite material that mitigates thermal stress of the insert.

3. The electron collector of claim 2, wherein the metal matrix composite material comprises a reinforcement material embedded into a base material.

4. The electron collector of claim 2, wherein the metal matrix composite material comprises: copper alloy reinforced with aluminum oxide, cobalt reinforced with tungsten carbide, steel reinforced with boron nitride, copper-silver alloy reinforced with diamond, or combinations thereof.

5. The electron collector of claim 1, wherein the inner surface of the base and the outer surface of the at least one insert are threaded for removably securing the at least one insert to the base.

6. The electron collector of claim 1, wherein the at least one insert has a thickness of between about 0.25 to about 0.75 inch.

7. The electron collector of claim 1, wherein the at least one insert comprises a plurality of inserts.

8. The electron collector of claim 7, wherein each of the plurality of inserts are fins attached to an inner surface of the base.

9. The electron collector of claim 1, further comprising at least one cooling channel extending through the base.

10. The electron collector of claim 1, further comprising a coating disposed on the outer surface of the at least one insert for joining the at least one insert to the base.

11. A system for capturing electrons, the system comprising:
an x-ray tube comprising:
a frame;
a cathode;
an anode; and
an electron collector attached to the frame at an area of high temperature on the x-ray tube, the electron collector comprising:
a base; and
at least one insert disposed within the base for mitigating thermal stress of the electron collector.

12. The system of claim 11, wherein the at least one insert comprises a metal matrix composite material.

13. The system of claim 11, wherein the at least one insert has a tapered inner surface or a curved inner surface.

14. The system of claim 11, wherein the at least one insert is removably secured to an inner surface of the base.

15. The system of claim 11, wherein the at least one insert is disposed in a location on an inner surface of the base that receives a relatively high thermal stress compared to other locations of the base.

16. The system of claim 11, wherein the electron collector is disposed in a location on the x-ray tube that receives a relatively high thermal stress compared to other locations of the x-ray tube.

17. A method for capturing electrons of an x-ray tube, said x-ray tube comprising an anode and a cathode within a vacuum, the method comprising the steps of:
emitting electrons from the cathode towards the anode to form an electron beam;
absorbing backscattered and secondary electrons with an electron collector disposed between the cathode and the anode, the electron collector comprising:
a base attached to the x-ray tube; and
at least one insert disposed within the base; and
mitigating thermal stress from the electron collector using the at least one insert.

18. The method of claim 17, wherein the insert is tapered or curved, further comprising focusing the electrons with the tapered or curved insert.

19. The method of claim 17, further comprising the steps of:
determining a location of relatively high thermal stress on an inner surface of the base compared to other locations along the inner surface of the base; and
disposing the insert at the location of relatively high thermal stress.

20. The method of claim 17, wherein the insert comprises a metal matrix composite material and a reinforcement material dispersed therein, further comprising:
blocking movement of dislocations within the metal matrix composite material by using a reinforcement material to mitigate thermal stress.
